(19) United States
(12) Patent Application Publication
(10) Pub. No.: US 2026/0304454 A1
(43) Pub. Date: Oct. 1, 2026

(54) ELECTRONIC APPARATUS AND METHOD FOR TRANSMITTING END AND RECEIVING END FOR SIDELINK COMMUNICATION

(71) Applicant: Sony Group Corporation, Tokyo (JP)

(72) Inventors: Xiaoxue WANG, Beijing (CN); Chen SUN, Beijing (CN)

(73) Assignee: Sony Group Corporation, Tokyo (JP)

(21) Appl. No.: 19/480,074

(22) PCT Filed: Jun. 3, 2024
(86) PCT No.: PCT/CN2024/096960

§ 371 Date: Oct. 30, 2025

(30) Foreign Application Priority Data
Jun. 9, 2023 (CN) 202310685867.4

(51) Int. Cl. H04W 72/25; H04B 7/06; H04L 5/00

(52) U.S. Cl. CPC H04W 72/25; H04B 7/06952; H04L 5/0094

(57) ABSTRACT

The present disclosure provides an electronic apparatus and method for a transmitting end device and a receiving end device for sidelink communication. The electronic apparatus for a transmitting end device for sidelink communication comprises: a processing circuit configured to: generate sidelink control information (SCI) when a receiving end device in communication with a sidelink executes a beam-based communication, the SCI comprising information of a resource usage and/or reservation condition of a communication beam in the preceding sidelink communication of a transmitting end device; and carry the SCI on a control channel to be sent to the receiving end device by means of the current beam.

This application claims priority to Chinese Patent Application No. 202310685867.4 titled “ELECTRONIC APPARATUS AND METHOD FOR TRANSMITTING END AND RECEIVING END FOR SIDELINK COMMUNICATION”, filed on Jun. 9, 2023 with the China National Intellectual Property Administration, which is incorporated herein by reference in its entirety.

### FIELD

The present disclosure relates to the technical field of wireless communications, and in particular to transmission of control information in sidelink (SL) communications. In particular, the present disclosure relates to an electronic device and method for a transmitting end apparatus and a receiving end apparatus for SL communications, and a computer-readable storage medium.

### BACKGROUND

In SL researches of Rel-18, in order to improve the throughput of terminals in sidelink communications and support higher-speed services such as XR, an FR2 band (such as a millimeter wave band) is introduced.

When the terminals operate in the FR2 frequency band, communication between the terminals is based on beams. Since a beam has a directional attribute, the terminal can only transmit reference signals and data in a direction of the beam.

FIG. 1 shows a schematic diagram of beam-based SL communication between user equipment (UE) as an example of a terminal. For example, when UE A operates in the FR2 frequency band, UE A sends control information based on the beam, and sending and receiving of the control information can only be performed within a coverage of the beam. Any UE outside the coverage of the beam cannot receive resource utilization information of UE A.

In the example of FIG. 1, UE A, UE B, and UE C communicate with each other through different beams, and transmit sidelink control information (SCI) through the beams, correspondingly. In this case, UE C cannot obtain any information about SCI 1, and therefore cannot know which time-frequency resources UE A has selected to communicate with UE B. Hence, UE C may select the same time-frequency resources as UE A to communicate with UE B, making it impossible for UE B to correctly receive communication data from UE A or UE C.

Therefore, in SL communication for the FR1 band, the manner of selecting time-frequency resource by simply multiplexing the time-frequency resource in the SL communication for the FR1 band causes conflicts in the selecting of the time-frequency resource, because time-frequency resource utilization of the surrounding terminals cannot be fully understood.

### SUMMARY

Hereinafter provided is a brief summary of the present disclosure, which is intended to provide a basic understanding of aspects of the present disclosure. It should be understood that this summary is not an exhaustive overview of the present disclosure. The summary is not intended to identify key or critical portions of the present disclosure or to delineate the scope of the present disclosure. The purpose is merely to present some concepts in a simplified form, as a prelude to the more detailed description that is presented later.

According to an aspect of the present disclosure, an electronic device for a transmitting end apparatus of sidelink (SL) communications is provided. The electronic device includes processing circuitry, configured to: generate sidelink control information (SCI) in performing beam-based communication with a receiving end apparatus of the sidelink communications, the SCI including information of resource utilization and/or preservation conditions of a communication beam in previous sidelink communications of the transmitting end apparatus; and carry the SCI on a control channel to be transmitted to the receiving end apparatus via a current beam.

According to another aspect of the present disclosure, a method for a transmitting end apparatus of SL communications is provided. The method includes: generating SCI in performing beam-based communication with a receiving end apparatus of the sidelink communications, the SCI including information of resource utilization and/or preservation conditions of a communication beam in previous SL communications of the transmitting end apparatus; and carrying the SCI on a control channel to be transmitted to the receiving end apparatus via a current beam.

According to an aspect of the present disclosure, an electronic device for a receiving end apparatus of SL communications is provided. The electronic device includes processing circuitry, configured to: in performing beam-based communication with a transmitting end apparatus of the SL communications, receive a control channel in a current beam from the transmitting end apparatus; and determine SCI based on the control channel, the SCI including information of resource utilization and/or preservation conditions of a communication beam in previous sidelink communications of the transmitting end apparatus.

According to an aspect of the present disclosure, a method for a receiving end apparatus of SL communications is provided. The method includes: in performing beam-based communication with a transmitting end apparatus of the SL communications, receiving a control channel in a current beam from the transmitting end apparatus; and determining SCI based on the control channel, the SCI including information of resource utilization and/or preservation conditions of a communication beam in previous sidelink communications of the transmitting end apparatus.

According to an aspect of the present disclosure, an electronic device for a transmitting end apparatus of SL communications is provided. The electronic device includes processing circuitry, configured to: generate SCI and carry the SCI on a control channel in performing beam-based communication with a receiving end apparatus of the SL communications; and transmit the control channel via a first beam and transmit a data channel via a second beam in one time slot, where a beam width of the first beam is larger than a beam width of the second beam.

According to another aspect of the present disclosure, a method for a transmitting end apparatus of SL communications is provided. The method includes: generating SCI and carrying the SCI on a control channel in performing beam-based communication with a receiving end apparatus of the SL communications; and transmitting the control channel via a first beam and transmitting a data channel via a second beam in one time slot, where a beam width of the first beam is larger than a beam width of the second beam.

According to an aspect of the present disclosure, an electronic device for a receiving end apparatus of SL communications is provided. The electronic device includes processing circuitry, configured to: in performing beam-based communication with a transmitting end apparatus of the SL communications, receive a first beam including a control channel and a second beam including a data channel from the transmitting end apparatus, where the first beam and the second beam are transmitted in one time slot and a beam width of the first beam is larger than a beam width of the second beam; and determine SCI based on the control channel in the first beam.

According to an aspect of the present disclosure, a method for a receiving end apparatus of SL communications is provided. The method includes: in performing beam-based communication with a transmitting end apparatus of the SL communications, receiving a first beam including a control channel and a second beam including a data channel from the transmitting end apparatus, where the first beam and the second beam are transmitted in one time slot and a beam width of the first beam is larger than a beam width of the second beam; and determining SCI based on the control channel in the first beam.

According to other aspects of the present disclosure, computer program codes and a computer program product for implementing the above-described method and a computer-readable storage medium having the computer program codes for implementing the method stored thereon are further provided.

With the electronic device and method according to the embodiments of the present disclosure, the receiving end apparatus in the beam-based SL communications is enabled to obtain as much information as possible of utilization of time-frequency resources, determine the utilization of time-frequency resources more accurately and thereby select non-conflicting time-frequency resources for communication, so that reliability of the communication is improved.

These and other advantages of the present disclosure become more apparent through preferred embodiments of the present disclosure described in detail below in conjunction with accompany drawings.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a schematic diagram of beam-based SL communication between UEs;

FIG. 2 is a block diagram showing functional modules of an electronic device for a transmitting end apparatus of SL communications according to an embodiment of the present disclosure;

FIG. 3 shows an example of time slot design according to an embodiment;

FIG. 4 shows another example of time slot design according to an embodiment;

FIG. 5 is a block diagram showing functional modules of an electronic device for a receiving end apparatus of SL communications according to another embodiment of the present disclosure;

FIG. 6 is a block diagram showing functional modules of an electronic device for a transmitting end apparatus of SL communications according to an embodiment of the present disclosure;

FIG. 7 shows an example of time slot design according to an embodiment;

FIG. 8 shows another example of time slot design according to an embodiment;

FIG. 9 is a block diagram showing functional modules of an electronic device for a receiving end apparatus of SL communications according to an embodiment of the present disclosure;

FIG. 10 shows a flow chart of a method for a transmitting end apparatus of SL communications according to an embodiment of the present disclosure;

FIG. 11 shows a flow chart of a method for a receiving end apparatus of SL communications according to another embodiment of the present disclosure;

FIG. 12 shows a flow chart of a method for a transmitting end apparatus of SL communications according to an embodiment of the present disclosure;

FIG. 13 shows a flow chart of a method for a receiving end apparatus of SL communications according to another embodiment of the present disclosure;

FIG. 14 is a block diagram showing an example of a schematic configuration of a smart phone to which the technology of the present disclosure is applicable;

FIG. 15 is a block diagram showing an example of a schematic configuration of an automobile navigation device to which the technology of the present disclosure is applicable; and

FIG. 16 is a block diagram of an exemplary structure of a general-purpose personal computer in which a method and/or apparatus and/or system according to an embodiment of the present disclosure may be implemented.

### DETAILED DESCRIPTION

Exemplary embodiments of the present disclosure are described below in conjunction with the drawings. For the sake of clarity and conciseness, not all features of an actual embodiment are described in the specification. However, it is to be appreciated that numerous implementation-specific decisions shall be made while implementing any of such actual embodiments so as to achieve specific objectives of a developer, for example, to comply with system-and business-related constraining conditions which vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

### First Embodiment

As mentioned above, in beam-based SL communication, a beam is directional, which is different from the omnidirectional transmission in a low frequency band FR1 in existing SL communication. Therefore, an existing SCI transmission method cannot be directly applied. In view of this, a transmission scheme for SCI for beam-based SL communication is provided in the embodiment. It should be understood that the beam-based SL communication described here may be SL communication using millimeter wave technology, but is not limited thereto, and covers all beam-based SL communications that perform directional transmission.

FIG. 2 shows a block diagram of functional modules of an electronic device 100 for a transmitting end apparatus of SL communications according to an embodiment. As shown in FIG. 2, the electronic device 100 includes a generation unit 101 and a communication unit 102. The generation unit is configured to generate SCI in performing beam-based communication with a receiving end apparatus of the SL communications, the SCI including information of resource utilization and/or preservation conditions of a communication beam in previous SL communications of the transmitting end apparatus. The communication unit is configured to carry the SCI on a control channel to be transmitted to the receiving end apparatus via a current beam.

The generation unit 101 and the communication unit 102 may be implemented by one or more processing circuits. The processing circuits may be implemented as a chip or a processor, for example. It should be understood that various functional units in the electronic device shown in FIG. 2 are only logical modules determined based on specific functions thereof, and are not intended to limit a specific implementation.

The electronic device 100, for example, is provided on a wireless communication terminal side or is communicably connected to a wireless communication terminal. The wireless communication terminal here may be various UE or user terminals, or may be a communication terminal such as a mobile base station. For example, the electronic device 100 is arranged on a transmitting end apparatus side.

The electronic device 100 may be implemented at a chip level or at a device level. For example, the electronic device 100 may operate as the wireless communication terminal itself and may further include an external device such as a memory, a transceiver (not shown), and the like. The memory may store related data information and programs that the wireless communication terminal needs to execute to achieve various functions. The transceiver may include one or more communication interfaces to support communications with different devices (such as another wireless communication terminal, a base station, a core network, and the like). An implementation of the transceiver is not specifically limited here.

In SL communications, a minimum time granularity of scheduling is a time slot. In the time slot, a control channel is arranged first, and then a shared channel (data channel) is arranged. The control channel may carry SCI to provide control information for a present SL communication.

In the embodiment, the SCI includes not only information of resource utilization and/or preservation conditions of a current beam in the present SL communication, but also information of resource utilization and/or preservation conditions of a communication beam in previous SL communications of the transmitting end apparatus. For example, the transmitting end apparatus establishes a PC5 communication link with another terminal apparatus in a previous SL communication and uses a same communication resource pool. The receiving end apparatus of the present SL communication expects to obtain more information about resource utilization of the communication resource pool. Hence, the receiving end apparatus can have a more comprehensive understanding of a utilization condition of time-frequency resources, and thereby a probability of conflict is reduced when selecting time-frequency resources.

For example, the SCI includes a first SCI and at least one second SCI, the first SCI includes information of resource utilization and/or preservation conditions of the current beam, and the at least one second SCI includes information of resource utilization and/or preservation conditions of a communication beam in the previous SL communications. There may be multiple preceding communication beams, and thus there may be multiple second SCIs.

The number of the second SCIs included in the SCI may be determined statically or dynamically. For example, in a case of static determination, the number of second SCIs included in the SCI may be configured by a base station or may be pre-configured. The generating unit 101 may determine SCI of which of previous beams is to be provided as the second SCI to the receiving end apparatus. For example, the generation unit may preferentially select SCI of a recently used communication beam.

In a case of dynamic determination, the generation unit 101 may determine the number of second SCIs included in the SCI based on a frequency domain size of time-frequency resources occupied by a current beam-based SL communication and the number of communication beams in the previous SL communications of the transmitting end apparatus. For example, the number of frequency domain resources for the current SL communication is N, and the number of previous communication beams is M. In a case of N>M, the SCI of all the previous beams is transmitted; and otherwise, only the SCI of the first N-1 communication beams is transmitted. Similarly, the generating unit 101 may determine SCI of which of previous beams is to be provided as the second SCI to the receiving end apparatus. For example, the generation unit may preferentially select SCI of a recently used communication beam.

Here, the SCI includes at least information of resource utilization and/or preservation conditions of a communication beam in an immediately previous SL communication of the transmitting end apparatus.

For example, the first SCI corresponds to a first control channel, the at least one second SCI corresponds to at least one second control channel, the first control channel occupies a first sub-channel in the frequency domain, the at least one second control channel occupies at least one second sub-channel in the frequency domain, and the first sub-channel and the at least one second sub-channel correspond to different frequencies. That is, multiple control channels are set in one time slot, and each control channel carries a SCI corresponding thereto. The control channel is, for example, a physical sidelink control channel (PSCCH).

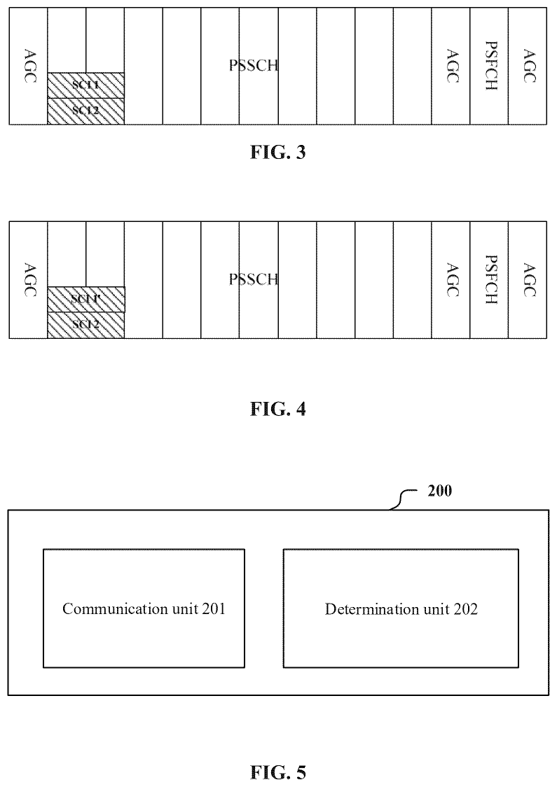

FIG. 3 shows an example of time slot design according to an embodiment. A PSCCH carries SCI, such as the first stage of the SCI, and may occupy one sub-channel (sub_channel) in the frequency domain and occupy 2 or 3 orthogonal frequency division multiplexing (OFDM) symbols in the time domain, as shown by the diagonal filled section in FIG. 3. The remaining sub-channels of this transmission may be used for transmitting a physical sidelink shared channel (PSSCH), as shown by the gray filled section in FIG. 3. The time slot shown further includes an OFDM symbol for automatic gain control (AGC) and an OFDM symbol corresponding to a physical sidelink feedback channel (PSFCH).

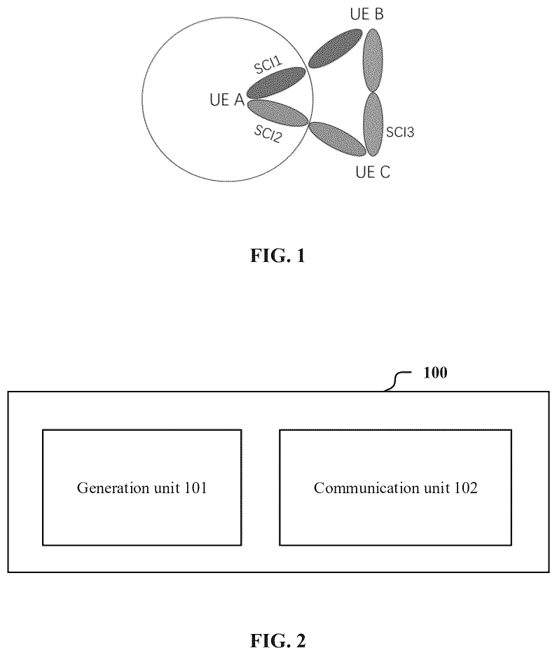

In the example of FIG. 3, two control channels are set in one time slot, each of the two control channels respectively carries SCI 2 (an example of the first SCI) and SCI 1 (an example of the second SCI). This example corresponds to the scenario diagram shown in FIG. 1, in which UE A, after communicating with UE B via beam 1, switches to beam 2 to communicate with UE C. SCI 2 is control information for current SL communication, corresponds to current beam 2 and is carried on the first sub-channel. SCI 1 is control information for previous SL communication, corresponds to previous beam 1 and is carried on the second sub-channel. As can be seen, different control channels occupy different sub-channels but occupy same OFDM symbols (for example, 2 or 3 OFDM symbols).

The first sub-channel may be a sub-channel with the lowest frequency for transmission resources, and the at least one second sub-channel may be sub-channels with frequencies increased sequentially from the lowest frequency for the first sub-channel. In this way, the receiving end apparatus may receive and decode the SCI of the current SL communication on the sub-channel with the lowest frequency, and receive and decode the SCI of the previous SL communication of the transmitting end apparatus on the sub-channel with the increased frequencies.

In the above solution, a structure of the physical layer of the SL transmission block is changed, possibly causing a problem of backward compatibility. For example, an R16 terminal cannot parse a transmission block of an R18 terminal. In view of this, in an example, a field for indicating whether additional SCI exists may be added to the SCI, so that the receiving end apparatus is enabled to determine, based on the field, whether to receive and decode the additional SCI.

For example, the first SCI may include a first field for indicating whether at least one second control channel exists. The second SCI may further include a first field for indicating whether there is a subsequent second control channel in a direction away from a frequency of the first control channel. The first field may be located in the first stage of the SCI and occupies 1 bit. For example, the first field may be configured to: indicate absence of a second control channel in a case where the first field of the first SCI is assigned with a value of 0, and indicate absence of a subsequent second control channel in a case where the first field of the second SCI is assigned with a value of 0. It should be understood that the value defined for the first field here is not restrictive.

On determining that the first field of the first SCI is 0, the receiving end apparatus learns that there is only one control channel in the time slot. On determining that the first field of the first SCI is 1, the receiving end apparatus learns that there are multiple control channels in the time slot. In this case, the receiving end apparatus may receive and decode the second SCI in a sub-channel (corresponding to an increased frequency) having an index greater than an index of the sub-channel where the first SCI is located by 1, until the first field in the second SCI is 0.

In addition, the second SCI may not include the first field. For example, in a case where the number of second SCIs is determined in a static manner, for example, configured by a base station or pre-configured, the second SCI may not include the first field. For example, a same number of second SCIs may be configured by the base station for each UE, or a same number of second SCIs may be pre-configured for each UE.

In the above example, the second SCI has the same format as the first SCI, that is, the format of the SCI is not changed for each SL communication. In another example, considering that the receiving end apparatus may only need the resource utilization and/or preservation conditions of a communication beam in the previous SL communications, other SCI information unrelated to the resource utilization and/or preservation, such as other information of the first stage of the SCI, information of the second stage of the SCI, Beta offset indicator, Number of DMRS port, Modulation and coding scheme, Additional MCS table indicator, or PSFCH overhead indication, may be omitted.

Therefore, in another example, different from the above example, the format of the second SCI may be modified to obtain a new format. For example, the second SCI may include only information of resource utilization and/or preservation conditions of a communication beam in the previous SL communications. In this way, signaling overhead is reduced. Alternatively, the second SCI may include only information of the resource preservation conditions of a communication beam in the previous SL communications.

FIG. 4 shows another example of time slot design according to an embodiment. This example also corresponds to the scenario diagram shown in FIG. 1, in which UE A, after communicating with UE B via beam 1, switches to beam 2 to communicate with UE C. Different from FIG. 3, the SCI transmitted here includes the control information SCI 2 of the current SL communication and the control information SCI 1′ of the previous SL communication with a new format. The SCI 1′ includes only information of resource utilization and/or preservation conditions of the SL communication between UE A and UE B.

For example, the second SCI may further include a first field. In this case, the receiving end apparatus may determine, based on the first field in the second SCI, whether to continue to receive and decode additional resource information.

In addition, the second SCI may not include the first field. That is, the first SCI includes a first field for indicating whether the second SCI exists, and the second SCI includes only information of resource utilization and/or preservation conditions of a communication beam in one or more previous SL communications. In this case, information of previous resource utilization and/or preservation may be placed in one second SCI. Alternatively, multiple second SCIs may be set, and the number of the second SCIs may be determined in a static manner, for example, configured by a base station or pre-configured.

On the other hand, the first SCI may further include a second field for indicating whether the second SCI includes only information of resource utilization and/or preservation conditions of a communication beam in previous SL communications. In other words, the first SCI may further include a second field indicating whether the second SCI is in the above-mentioned new format. For example, the second field occupies 1 bit, and indicates that the second SCI has a new format in a case where the second field is assigned with a value of 1.

In summary, the electronic device 100 according to the embodiment provides the information of resource utilization and/or preservation in previous SL communications, so that the receiving end apparatus is enabled to obtain as much information as possible of utilization of time-frequency resources, determine the utilization of time-frequency resources more accurately and thereby select non-conflicting time-frequency resources for communication, so that reliability of the communication is improved.

### Second Embodiment

FIG. 5 is a block diagram showing functional modules of an electronic device 200 for a receiving end apparatus of SL communications according to another embodiment of the present disclosure. As shown in FIG. 5, the electronic device 200 includes a communication unit 201 and a determination unit 202. The communication unit 201 is configured to: in performing beam-based communication with a transmitting end apparatus of the SL communications, receive a control channel in a current beam from the transmitting end apparatus. The determination unit 202 is configured to determine SCI based on the control channel, the SCI including information of resource utilization and/or preservation conditions of a communication beam in previous sidelink communications of the transmitting end apparatus.

The communication unit 201 and the determination unit 202 may be implemented by one or more processing circuits. The processing circuits may be implemented as a chip or a processor, for example. It should be understood that various functional units in the electronic device shown in FIG. 5 are only logical modules determined based on specific functions thereof, and are not intended to limit a specific implementation.

The electronic device 200, for example, is provided on a wireless communication terminal side or is communicably connected to a wireless communication terminal. The wireless communication terminal here may be various UE or user terminals, or may be a communication terminal such as a mobile base station. For example, the electronic device 200 is arranged on a receiving end apparatus side.

The electronic device 200 may be implemented at a chip level or at a device level. For example, the electronic device 200 may operate as the wireless communication terminal itself and may further include an external device such as a memory, a transceiver (not shown), and the like. The memory may store related data information and programs that the wireless communication terminal needs to execute to achieve various functions. The transceiver may include one or more communication interfaces to support communications with different devices (such as another wireless communication terminal, a base station, a core network, and the like). An implementation of the transceiver is not specifically limited here.

Similar to the first embodiment, the SCI includes not only information of resource utilization and/or preservation conditions of a current beam in the present SL communication, but also information of resource utilization and/or preservation conditions of a communication beam in previous SL communications of the transmitting end apparatus.

For example, the SCI includes a first SCI and at least one second SCI, the first SCI includes information of resource utilization and/or preservation conditions of the current beam, and the at least one second SCI includes information of resource utilization and/or preservation conditions of a communication beam in the previous SL communications. There may be multiple preceding communication beams, and thus there may be multiple second SCIs.

The number of the second SCIs included in the SCI may be determined statically or dynamically. For example, in a case of static determination, the number of second SCIs included in the SCI may be configured by a base station or may be pre-configured. In a case of dynamic determination, the transmitting end apparatus may determine the number of second SCIs included in the SCI based on a frequency domain size of time-frequency resources occupied by a current beam-based SL communication and the number of communication beams in the previous SL communications of the transmitting end apparatus. In addition, the transmitting end apparatus determines SCI of which of previous beams is to be provided as the second SCI to the receiving end apparatus. For example, the transmitting end apparatus may preferentially select SCI of a recently used communication beam.

For example, the SCI includes at least information of resource utilization and/or preservation conditions of a communication beam in an immediately previous SL communication of the transmitting end apparatus.

For example, the first SCI corresponds to a first control channel, the at least one second SCI corresponds to at least one second control channel, the first control channel occupies a first sub-channel in the frequency domain, the at least one second control channel occupies at least one second sub-channel in the frequency domain, and the first sub-channel and the at least one second sub-channel correspond to different frequencies. Each control channel may occupy 2 or 3 OFDM symbols in the time domain. The first sub-channel may be a sub-channel with the lowest frequency for transmission resources, and the at least one second sub-channel may be sub-channels with frequencies increased sequentially from the lowest frequency for the first sub-channel. In this way, the receiving end apparatus may receive and decode the SCI of the current SL communication on the sub-channel with the lowest frequency, and receive and decode the SCI of the previous SL communication of the transmitting end apparatus on the sub-channel with the increased frequency.

An example of a time slot including such a control channel is described with reference to FIG. 3 in the first embodiment, and is not repeated here.

In the above solution, a structure of the physical layer of the SL transmission block is changed, possibly causing a problem of backward compatibility. For example, an R16 terminal cannot parse a transmission block of an R18 terminal. In view of this, in an example, a field for indicating whether an additional SCI exists may be added to the SCI, so that the receiving end apparatus is enabled to determine, based on the field, whether to receive and decode the additional SCI.

For example, the first SCI may include a first field for indicating whether at least one second control channel exists. The second SCI may further include a first field for indicating whether there is a subsequent second control channel in a direction away from a frequency of the first control channel. The first field may be located in the first stage of the SCI and occupies 1 bit. For example, the first field may be configured to: indicate absence of a second control channel in a case where the first field of the first SCI is assigned with a value of 0, and indicate absence of a subsequent second control channel in a case where the first field of the second SCI is assigned with a value of 0. It should be understood that the value defined for the first field here is not restrictive.

The determination unit 202 is configured to sequentially determine a value of the first field to determine whether there is a subsequent second control channel, until the value of the first field is 0. For example, on determining that the first field of the first SCI is 0, the determination unit 202 learns that there is only one control channel in the time slot. On determining that the first field of the first SCI is 1, the determination unit 202 learns that there are multiple control channels in the time slot. In this case, the second SCI may be received and decoded in a sub-channel (corresponding to an increased frequency) having an index greater than an index of the sub-channel where the first SCI is located by 1, until the first field in the second SCI is 0.

In addition, the second SCI may not include the first field. For example, in a case where the number of second SCIs is determined in a static manner, for example, configured by a base station or pre-configured, the second SCI may not include the first field. For example, a same number of second SCIs may be configured by the base station for each UE, or a same number of second SCIs may be pre-configured for each UE.

In the above example, the second SCI has the same format as the first SCI, that is, the format of the SCI is not changed for each SL communication. In another example, considering that the receiving end apparatus may only need the resource utilization and/or preservation conditions of a communication beam in the previous SL communications, other SCI information unrelated to the resource utilization and/or preservation may be omitted.

Therefore, in another example, different from the above example, the format of the second SCI may be modified to obtain a new format. For example, the second SCI may include only information of resource utilization and/or preservation conditions of a communication beam in the previous SL communications of the transmitting end apparatus. In this way, signaling overhead is reduced. Alternatively, the second SCI may include only information of the resource preservation conditions of a communication beam in the previous SL communications of the transmitting end apparatus.

An example of a time slot including such a control channel is described with reference to FIG. 4 in the first embodiment, and is not repeated here.

For example, the second SCI may further include a first field. In this case, the determination unit 202 may determine, based on the first field in the second SCI, whether to continue to receive and decode additional resource information.

In addition, the second SCI may not include the first field. That is, the first SCI includes a first field for indicating whether the second SCI exists, and the second SCI includes only information of resource utilization and/or preservation conditions of a communication beam in one or more previous SL communications of the transmitting end apparatus. In this case, information of previous resource utilization and/or preservation of the transmitting end apparatus may be placed in one second SCI. Alternatively, multiple second SCIs may be set, and the number of the second SCIs may be determined in a static manner, for example, configured by a base station or pre-configured.

On the other hand, the first SCI may further include a second field for indicating whether the second SCI includes only information of resource utilization and/or preservation conditions of a communication beam in previous SL communications of the transmitting end apparatus. In other words, the first SCI may further include a second field indicating whether the second SCI is in the above-mentioned new format. For example, the second field occupies 1 bit, and the determination unit 202 determines, based on the second field, that the second SCI has a new format in a case where the second field is assigned with a value of 1.

In summary, the electronic device 200 according to the embodiment obtains the information of resource utilization and/or preservation in previous SL communications, being enabled to obtains as much information as possible of utilization of time-frequency resources, determine the utilization of time-frequency resources more accurately and thereby select non-conflicting time-frequency resources for communication, so that reliability of the communication is improved.

### Third Embodiment

FIG. 6 is a block diagram of functional modules of an electronic device 300 for a transmitting end apparatus of SL communications according to an embodiment of the present disclosure. As shown in FIG. 6, the electronic device 300 includes a generation unit 301 and a communication unit 302. The generation unit 301 is configured to generate SCI and carry the SCI on a control channel in performing beam-based communication with a receiving end apparatus of the SL communications. The communication unit 302 is configured to transmit the control channel via a first beam and transmit a data channel via a second beam in one time slot, where a beam width of the first beam is larger than a beam width of the second beam.

The generation unit 301 and the communication unit 302 may be implemented by one or more processing circuits. The processing circuits may be implemented as a chip or a processor, for example. It should be understood that various functional units in the electronic device shown in FIG. 6 are only logical modules determined based on specific functions thereof, and are not intended to limit a specific implementation.

The electronic device 300, for example, is provided on a wireless communication terminal side or is communicably connected to a wireless communication terminal. The wireless communication terminal here may be various UE or user terminals, or may be a communication terminal such as a mobile base station. For example, the electronic device 100 is arranged on a transmitting end apparatus side.

The electronic device 300 may be implemented at a chip level or at a device level. For example, the electronic device 300 may operate as the wireless communication terminal itself and may further include an external device such as a memory, a transceiver (not shown), and the likes. The memory may store related data information and programs that the wireless communication terminal needs to execute to achieve various functions. The transceiver may include one or more communication interfaces to support communications with different devices (such as another wireless communication terminal, a base station, a core network, and the like). An implementation of the transceiver is not specifically limited here.

In this embodiment, symbol-level beam switching is achieved. Different beams are used to transmit the control channel and the data channel in a same time slot. The first beam for transmitting the control channel has a large width, thereby providing a large coverage. The second beam for transmitting the data channel has a small width, thereby providing a high transmission quality.

For example, the first beam may be an omnidirectional beam. In this way, similar to R16, a terminal can receive SCI of SL communications of a surrounding terminal, so as to understand resource utilization of the surrounding terminal, as a reference for resource selection, to avoid or reduce conflicts.

FIG. 7 shows an example of time slot design according to an embodiment. In the figure, a time slot section corresponding to a control channel is filled with oblique lines, and a section corresponding to a data channel is filled with gray. An interval for AGC, for example, one OFDM symbol, is set between the control channel and the data channel. It should be noted that this is not restrictive.

In addition, the SCI here may be the SCI described in the first embodiment and the second embodiment. For example, the SCI includes a first SCI and at least one second SCI, the first SCI includes information of resource utilization and/or preservation conditions of the first beam and the second beam, and the at least one second SCI includes information of resource utilization and/or preservation conditions of a communication beam in the previous SL communications of the transmitting end apparatus. In other words, the first SCI includes control information of a present SL communication, and the second SCI includes control information of the previous SL communications. In this way, the amount of information of resource utilization and/or preservation that can be obtained by the receiving end apparatus is further increased. Especially in a case where the first beam is not an omnidirectional beam, such SCI format can serve as a beneficial supplement.

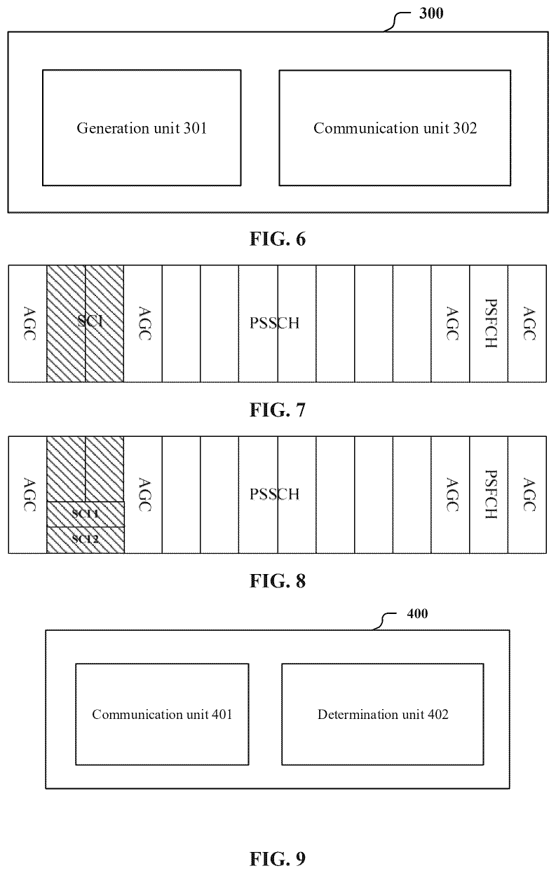

FIG. 8 shows an example of time slot design in this case. In FIG. 8, SCI 2 represents control information of a present SL communication, and SCI 1 represents control information of the previous SL communications of the transmitting end apparatus. Relevant descriptions in the first embodiment and the second embodiment are applicable to this embodiment and are not repeated here.

In summary, the electronic device 300 according to the embodiment transmits the control channel via a wide beam, so that the receiving end apparatus is enabled to obtain as much information as possible of utilization of time-frequency resources, determine the utilization of time-frequency resources more accurately and thereby select non-conflicting time-frequency resources for communication, so that reliability of the communication is improved.

### Fourth Embodiment

FIG. 9 is a block diagram of functional modules of an electronic device 400 for a receiving end apparatus of SL communications according to another embodiment of the present disclosure. As shown in FIG. 9, the electronic device 400 includes a communication unit 401 and a determination unit 402. The communication unit 401 is configured to: in performing beam-based communication with a transmitting end apparatus of the SL communications, receive a first beam including a control channel and a second beam including a data channel from the transmitting end apparatus, where the first beam and the second beam are transmitted in one time slot and a beam width of the first beam is larger than a beam width of the second beam. The determination unit 402 is configured to determine SCI based on the control channel in the first beam.

The communication unit 401 and the determination unit 402 may be implemented by one or more processing circuits. The processing circuits may be implemented as a chip or a processor, for example. It should be understood that various functional units in the electronic device shown in FIG. 9 are only logical modules determined based on specific functions thereof, and are not intended to limit a specific implementation.

The electronic device 400, for example, is provided on a wireless communication terminal side or is communicably connected to a wireless communication terminal. The wireless communication terminal here may be various UE or user terminals, or may be a communication terminal such as a mobile base station. For example, the electronic device 400 is arranged on the receiving end apparatus side.

The electronic device 400 may be implemented at a chip level or at a device level. For example, the electronic device 200 may operate as the wireless communication terminal itself and may further include a memory, a transceiver (not shown), and other external devices. The memory may store related data information and programs that the wireless communication terminal needs to execute to achieve various functions. The transceiver may include one or more communication interfaces to support communications with different devices (such as another wireless communication terminal, a base station, a core network, and the like). An implementation of the transceiver is not specifically limited here.

Similar to the third embodiment, in this embodiment, symbol-level beam switching is achieved. Different beams are used to transmit the control channel and the data channel in a same time slot. The first beam for transmitting the control channel has a large width, thereby providing a large coverage. The second beam for transmitting the data channel has a small width, thereby providing a high transmission quality. An interval for AGC may be set between the control channel and the data channel.

For example, the first beam may be an omnidirectional beam. In this way, similar to R16, a terminal can receive SCI of SL communications of a surrounding terminal, so as to understand resource utilization of the surrounding terminal, as a reference for resource selection, to avoid or reduce conflicts in the resource selection.

In addition, the SCI here may be the SCI described in the first embodiment and the second embodiment. For example, the SCI includes a first SCI and at least one second SCI, the first SCI includes information of resource utilization and/or preservation conditions of the first beam and the second beam, and the at least one second SCI includes information of resource utilization and/or preservation conditions of a communication beam in the previous SL communications of the transmitting end apparatus. In other words, the first SCI includes control information of a present SL communication, and the second SCI includes control information of the previous SL communications. In this way, the amount of information of resource utilization and/or preservation that can be obtained by the receiving end apparatus is further increased. Especially in a case where the first beam is not an omnidirectional beam, such SCI format can serve as a beneficial supplement.

An example of relevant time slot design is given in the third embodiment and is not repeated here.

In summary, the electronic device 400 according to the embodiment receives the control channel via a wide beam, being enabled to obtain as much information as possible of utilization of time-frequency resources, determine the utilization of time-frequency resources more accurately and thereby select non-conflicting time-frequency resources for communication, so that reliability of the communication is improved.

### Fifth Embodiment

In the description of the electronic devices for a receiving end apparatus and a transmitting end apparatus of SL communications in the above embodiments, some processes or methods are further disclosed. Hereinafter, an overview of the methods is given without repeating some of details discussed above. It should be noted that although disclosed in the description of the electronic devices for a receiving end apparatus and a transmitting end apparatus of SL communications, the methods do not necessarily adopt the components as described or be performed by those components. For example, the embodiments of the electronic devices for a receiving end apparatus and a transmitting end apparatus of SL communications may be implemented partially or entirely using hardware and/or firmware, while the methods for a receiving end apparatus and a transmitting end apparatus of SL communications discussed below may be implemented entirely by a computer-executable program, although the methods may employ the hardware and/or firmware for the electronic devices for a receiving end apparatus and a transmitting end apparatus of SL communications.

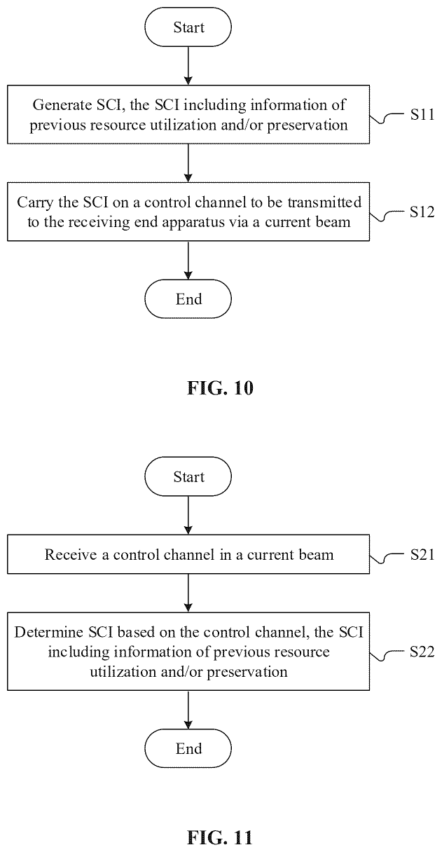

FIG. 10 shows a flow chart of a method for a transmitting end apparatus of SL communications according to an embodiment of the present disclosure. The method includes: generating (S11) SCI in performing beam-based communication with a receiving end apparatus of the sidelink communications, the SCI including information of resource utilization and/or preservation conditions of a communication beam in previous SL communications of the transmitting end apparatus; and carrying (S12) the SCI on a control channel to be transmitted to the receiving end apparatus via a current beam. The method may be performed on a transmitting end apparatus side, for example.

For example, the SCI includes a first SCI and at least one second SCI, the first SCI includes information of resource utilization and/or preservation conditions of the current beam, and the at least one second SCI includes information of resource utilization and/or preservation conditions of a communication beam in the previous SL communications.

The first SCI corresponds to a first control channel, the at least one second SCI corresponds to at least one second control channel, the first control channel occupies a first sub-channel in the frequency domain, the at least one second control channel occupies at least one second sub-channel in the frequency domain, and the first sub-channel and the at least one second sub-channel correspond to different frequencies. Each control channel occupies 2 or 3 OFDM symbols in the time domain.

The first sub-channel is a sub-channel of a lowest frequency for transmission resources, and the at least one second sub-channel is sub-channels with frequencies increased sequentially from the lowest frequency for the first sub-channel.

In an example, the first SCI includes a first field for indicating whether there is at least one second control channel, and the second SCI includes a first field for indicating whether there is a subsequent second control channel in a direction away from a frequency of the first control channel. The first field is located in the first stage of the SCI and occupies 1 bit, and is configured to: indicate absence of the second control channel in a case where the first field of the first SCI is assigned with a value of 0, and indicate absence of the subsequent second control channel in a case where the first field of the second SCI is assigned with a value of 0.

In another example, the second SCI includes, in addition to the first field, only information of resource utilization and/or preservation conditions of a communication beam in the previous sidelink communications.

In a further example, the SCI includes the first SCI and one second SCI, the first SCI includes a first field for indicating whether the second SCI exists, and the second SCI includes only information of resource utilization and/or preservation conditions of a communication beam in one or more previous SL communications.

In addition, the first SCI may further include a second field for indicating whether the second SCI includes only information of resource utilization and/or preservation conditions of a communication beam in previous sidelink communications.

The method further includes the following steps: determining the number of second SCIs included in the SCI in a dynamic or static manner. For example, the number of second SCIs included in the SCI may be configured by a base station or may be pre-configured. Alternatively, the number of second SCIs included in the SCI may be determined based on a frequency domain size of time-frequency resources occupied by a current beam-based SL communication and the number of communication beams in the previous SL communications of the transmitting end apparatus.

The SCI includes at least information of resource utilization and/or preservation conditions of a communication beam in an immediately previous sidelink communication of the transmitting end apparatus.

The above method corresponds to the electronic device 100 in the first embodiment, detailed description of which is given in the first embodiment and is not repeated here.

FIG. 11 shows a flow chart of a method for a receiving end apparatus of SL communications according to another embodiment of the present disclosure. The method includes: in performing beam-based communication with a transmitting end apparatus of the SL communications, receiving (S21) a control channel in a current beam from the transmitting end apparatus; and determining SCI based on the control channel, the SCI including information of resource utilization and/or preservation conditions of a communication beam in previous SL communications of the transmitting end apparatus. The method is performed on a receiving end apparatus side, for example.

For example, the SCI includes a first SCI and at least one second SCI, the first SCI includes information of resource utilization and/or preservation conditions of the current beam, and the at least one second SCI includes information of resource utilization and/or preservation conditions of a communication beam in the previous sidelink communications.

The first SCI corresponds to a first control channel, the at least one second SCI corresponds to at least one second control channel, the first control channel occupies a first sub-channel in the frequency domain, the at least one second control channel occupies at least one second sub-channel in the frequency domain, and the first sub-channel and the at least one second sub-channel correspond to different frequencies. Each control channel occupies 2 or 3 OFDM symbols in the time domain.

The first sub-channel is a sub-channel of a lowest frequency for transmission resources, and the at least one second sub-channel is sub-channels with frequencies increased sequentially from the lowest frequency for the first sub-channel.

In an example, the first SCI includes a first field for indicating whether there is at least one second control channel, and the second SCI includes a first field for indicating whether there is a subsequent second control channel in a direction away from a frequency of the first control channel. The first field is located in the first stage of the SCI and occupies 1 bit, and is configured to: indicate absence of a second control channel in a case where the first field of the first SCI is assigned with a value of 0, and indicate absence of the subsequent second control channel in a case where the first field of the second SCI is assigned with a value of 0. The method includes: sequentially determining a value of the first field to determine whether there is a subsequent second control channel, until the value of the first field is 0.

In another example, the second SCI includes, in addition to the first field, only information of resource utilization and/or preservation conditions of a communication beam in the previous SL communications of the transmitting end apparatus.

In a further example, the SCI includes the first SCI and one second SCI, the first SCI includes a first field for indicating whether the second SCI exists, and the second SCI includes only information of resource utilization and/or preservation conditions of a communication beam in one or more previous SL communications of the transmitting end apparatus.

In addition, the first SCI may further include a second field for indicating whether the second SCI includes only information of resource utilization and/or preservation conditions of a communication beam in previous SL communications of the transmitting end apparatus.

The SCI includes at least information of resource utilization and/or preservation conditions of a communication beam in an immediately previous sidelink communication of the transmitting end apparatus.

The above method corresponds to the electronic device 200 in the second embodiment, detailed description of which is given in the second embodiment and is not repeated here.

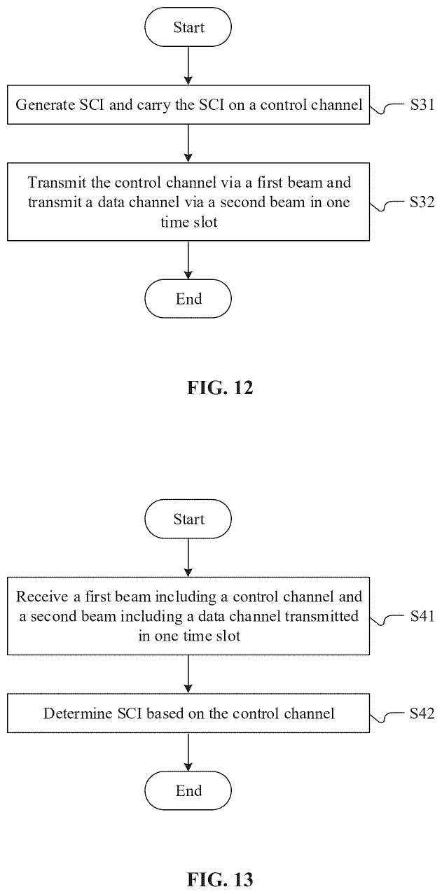

FIG. 12 shows a flow chart of a method for a transmitting end apparatus of SL communications according to another embodiment of the present disclosure. The method includes: (S31) generating SCI and carrying the SCI on a control channel in performing beam-based communication with a receiving end apparatus of the SL communications; and (S32) transmitting the control channel via a first beam and transmitting a data channel via a second beam in one time slot, where a beam width of the first beam is larger than a beam width of the second beam. The method may be performed on a transmitting end apparatus side, for example.

For example, the first beam is an omnidirectional beam. An interval for automatic gain control is set between the control channel and the data channel.

For example, the SCI includes a first SCI and at least one second SCI, the first SCI includes information of resource utilization and/or preservation conditions of the first beam and the second beam, and the at least one second SCI includes information of resource utilization and/or preservation conditions of a communication beam in the previous SL communications of the transmitting end apparatus.

The above method corresponds to the electronic device 300 in the third embodiment, detailed description of which is given in the third embodiment and is not repeated here.

FIG. 13 shows a flow chart of a method for a receiving end apparatus of SL communications according to another embodiment of the present disclosure. The method includes: in performing beam-based communication with a transmitting end apparatus of the SL communications, receiving (S41) a first beam including a control channel and a second beam including a data channel from the transmitting end apparatus, where the first beam and the second beam are transmitted in one time slot and a beam width of the first beam is larger than a beam width of the second beam; and determining (S42) SCI based on the control channel in the first beam. The method may be performed on a receiving end apparatus side, for example.

For example, the first beam is an omnidirectional beam. An interval for automatic gain control is set between the control channel and the data channel.

For example, the SCI includes first SCI and at least one second SCI, the first SCI includes information of resource utilization and/or preservation conditions of the first beam and the second beam, and the at least one second SCI includes information of resource utilization and/or preservation conditions of a communication beam in the previous SL communications of the transmitting end apparatus.

The above method corresponds to the electronic device 400 in the fourth embodiment, detailed description of which is given in the fourth embodiment and is not repeated here.

It is to be noted that the above methods can be used in combination or alone.

The technology of the present disclosure is applicable to various products.

For example, the electronic device 100 to electronic device 400 may be implemented as various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may be implemented as a terminal that performs machine-to-machine (M2M) communications (which is also referred to as a machine type communication (MTC) terminal). Furthermore, the user equipment may be a wireless communication module (such as an integrated circuit module including a single wafer) installed on each of the above-mentioned terminals.

### Application Example of User Equipment

### (First Application Example)

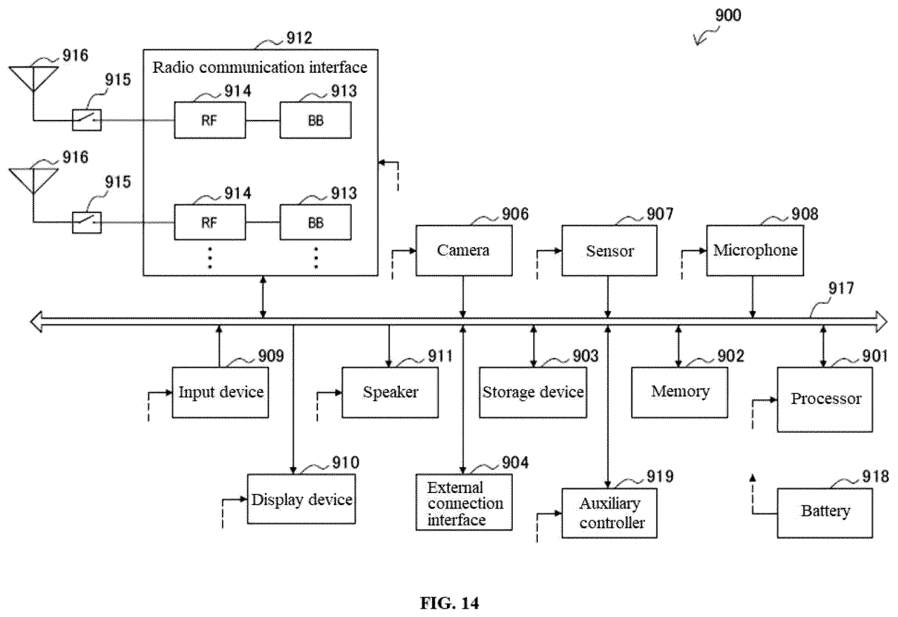

FIG. 14 is a block diagram showing an example of a schematic configuration of a smart phone 900 to which the technology of the present disclosure is applicable. The smart phone 900 includes a processor 901, a memory 902, a storage device 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on chip (SoC), and controls functions of the application layer and other layers of the smart phone 900. The memory 902 includes an RAM and an ROM, and stores data and programs executed by the processor 901. The storage device 903 may include a storage medium, such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter and an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 14, the radio communication interface 912 may include multiple BB processors 913 and multiple RF circuits 914. Although FIG. 14 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 14, the smart phone 900 may include multiple antennas 916. Although FIG. 14 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage device 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 14 via a feeder line. The feeder line is partially shown as a dashed line in the figure. The auxiliary controller 919 operates the least necessary function of the smart phone 900 in a sleep mode, for example.

In the smart phone 900 shown in FIG. 14, the communication unit 102 and a transceiver of the electronic device 100, the communication unit 201 and a transceiver of the electronic device 200, the communication unit 302 and a transceiver of the electronic device 300, and the communication unit 401 and a transceiver of the electronic device 400 may be implemented by the radio communication interface 912. At least part of the functions may be implemented by the processor 901 or the auxiliary controller 919. For example, the processor 901 or the auxiliary controller 919 may provide the receiving end apparatus with information of resource utilization and/or preservation conditions of a communication beam in previous SL communications of the transmitting end apparatus by executing functions of the generation unit 101 and the communication unit 102, so that the receiving end apparatus is enabled to have a more comprehensive understanding of resource utilization conditions and thereby perform resource selection appropriately. The processor 901 or the auxiliary controller 919 may obtain information of resource utilization and/or preservation conditions of a communication beam in previous SL communications of the transmitting end apparatus by executing functions of the communication unit 201 and the determination unit 202, so as to have a more comprehensive understanding of resource utilization conditions and thereby perform resource selection appropriately. The processor 901 or the auxiliary controller 919 may transmit the control channel via a wide beam by executing functions of the generation unit 301 and the communication unit 302, thereby improving a coverage of the SCI, so that the receiving end apparatus can have a more comprehensive understanding of resource utilization conditions and thereby perform resource selection appropriately. The processor 901 or the auxiliary controller 919 may receive the control channel transmitted via a wide beam by executing functions of the communication unit 401 and the determination unit 402, thereby obtaining SCI of a surrounding terminal, so that the receiving end apparatus can have a more comprehensive understanding of resource utilization conditions and thereby perform resource selection appropriately.

### (Second Application Example)

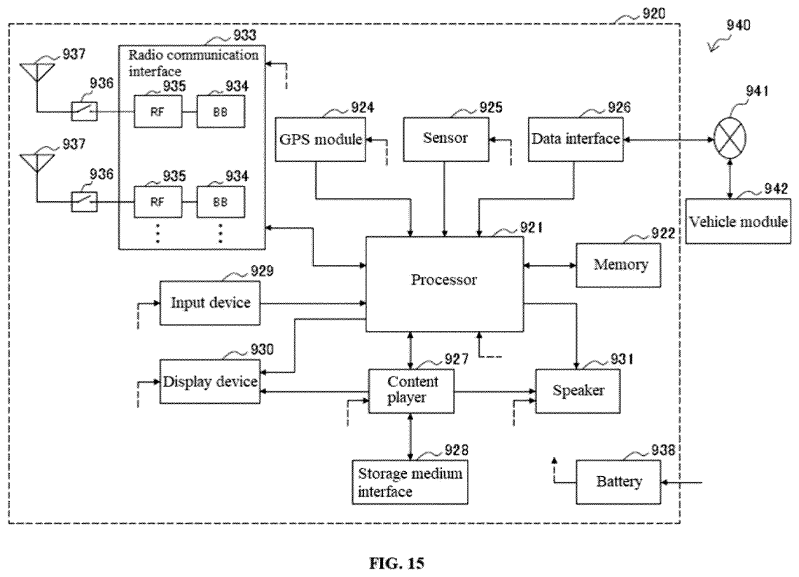

FIG. 15 is a block diagram showing an example of a schematic configuration of an automobile navigation device 920 to which the technology of the present disclosure is applicable. The automobile navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or SoC, and controls the navigation function and other functions of the automobile navigation device 920. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD) inserted into the storage medium interface 928. The input device 929 includes, for example, a touch sensor configured to detect a touch on a screen of the display device 930, a button, or a switch, and receives an operation or information inputted from a user. The display device 930 includes a screen such as an LCD or OLED display, and displays an image or reproduced content of a navigation function. The speaker 931 outputs a sound or reproduced content of the navigation function.

The radio communication interface 933 supports any cellular communication scheme (such as LTE and LTE-Advanced), and performs wireless communications. The radio communication interface 933 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter and an amplifier, and transmit and receive a wireless signal via the antenna 937. The radio communication interface 933 may be a chip module on which the BB processor 934 and the RF circuit 935 are integrated. As shown in FIG. 15, the radio communication interface 933 may include multiple BB processors 934 and multiple RF circuits 935. Although FIG. 15 shows an example in which the radio communication interface 933 includes multiple BB processors 934 and multiple RF circuits 935, the radio communication interface 933 may include a single BB processor 934 or a single RF circuit 935.

In addition to the cellular communication scheme, the radio communication interface 933 may support another type of wireless communication scheme, such as a short-range wireless communication scheme, a near field communication scheme, or a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 933.

Each of the antennas 937 includes a single or multiple antenna elements (such as multiple antenna elements included in a MIMO antenna), and is configured for the radio communication interface 933 to transmit and receive wireless signals. As shown in FIG. 15, the automobile navigation device 920 may include multiple antennas 937. Although FIG. 15 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 15 via a feeder line. The feeder line is partially shown as a dashed line in the figure. The battery 938 accumulates electric power supplied from the vehicle.

In the automobile navigation device 920 shown in FIG. 15, the communication unit 102 and a transceiver of the electronic device 100, the communication unit 201 and a transceiver of the electronic device 200, the communication unit 302 and a transceiver of the electronic device 300, and the communication unit 401 and a transceiver of the electronic device 400 may be implemented by the radio communication interface 933. At least part of the functions may be implemented by the processor 921. For example, the processor 921 may provide the receiving end apparatus with information of resource utilization and/or preservation conditions of a communication beam in previous SL communications of the transmitting end apparatus by executing functions of the generation unit 101 and the communication unit 102, so that the receiving end apparatus is enabled to have a more comprehensive understanding of resource utilization conditions and thereby perform resource selection appropriately. The processor 921 may obtain information of resource utilization and/or preservation conditions of a communication beam in previous SL communications of the transmitting end apparatus by executing functions of the communication unit 201 and the determination unit 202, so as to have a more comprehensive understanding of resource utilization conditions and thereby perform resource selection appropriately. The processor 921 may transmit the control channel via a wide beam by executing functions of the generation unit 301 and the communication unit 302, thereby improving a coverage of the SCI, so that the receiving end apparatus can have a more comprehensive understanding of resource utilization conditions and thereby perform resource selection appropriately. The processor 921 may receive the control channel transmitted via a wide beam by executing functions of the communication unit 401 and the determination unit 402, thereby obtaining SCI of a surrounding terminal, so that the receiving end apparatus can have a more comprehensive understanding of resource utilization conditions and thereby perform resource selection appropriately.

The technology of the present disclosure may be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with specific embodiments. However, it should be noted that those skilled in the art can understand that all or any steps or components of the methods and apparatuses of the present disclosure can be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the methods according to the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

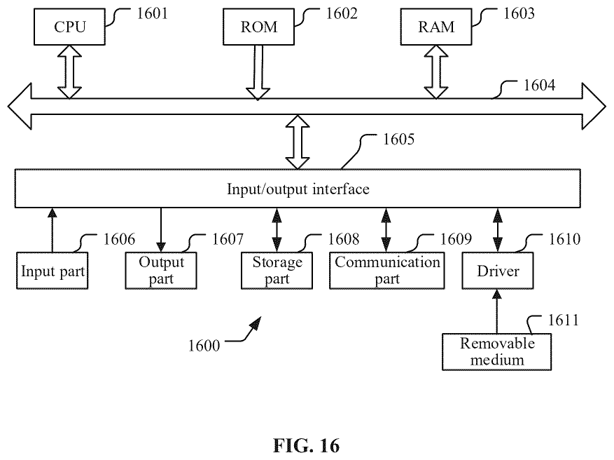

In a case of implementing the embodiments of the present disclosure in software or firmware, the program consisting of the software is mounted to a computer with a dedicated hardware structure (such as a general-purpose personal computer 1600 as shown in FIG. 16) from the storage medium or network. The computer, when mounted with various programs, performs various functions.

In FIG. 16, a central processing unit (CPU) 1601 executes various processes according to a program stored in a read-only memory (ROM) 1602 or a program loaded from a storage part 1608 to a random-access memory (RAM) 1603. In the RAM 1603, data required for the CPU 1601 to perform various processes or the like is stored as necessary. The CPU 1601, the ROM 1602 and the RAM 1603 are connected to each other via a bus 1604. An input/output interface 1605 is connected to the bus 1604.

The following components are connected to the input/output interface 1605: an input part 1606 (including a keyboard, a mouse, and the like), an output part 1607 (including a display, such as a cathode ray tube (CRT) and a liquid crystal display (LCD), a loudspeaker, and the like), a storage part 1608 (including a hard disk and the like), and a communication part 1609 (including a network interface card, such as a LAN card, and a modem). The communication part 1609 performs communication processing via a network, such as the Internet. A driver 1610 may be connected to the input/output interface 1605 as needed. A removable medium 1611, such as a magnetic disk, an optical disk, a magnetic optical disk, and a semiconductor memory, is mounted to the driver 1610 as required, so that a computer program read therefrom is mounted to the storage part 1608 as required.

In a case that the above processes are implemented by software, the program consisting the software is mounted from a network, such as the Internet, or from a storage medium, such as the removable medium 1611.

Those skilled in the art should understood that, the storage medium is not limited to the removable medium 1611, as shown in FIG. 16, which stores a program and is distributed separately from the device so as to provide the program for a user. Examples of the removable medium 1611 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1602, the hard disk contained in the storage part 1608, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a(n) . . . ” does not exclude existence of other identical elements in the process, method, article or device.

Although the embodiments of the present disclosure are described in detail above with reference to the accompanying drawings, it should be understood that the embodiments are only for illustrating the present disclosure and do not constitute a limitation of the present disclosure. For those skilled in the art, various modifications and changes can be made to the embodiments without departing from the essence and scope of the present disclosure. Therefore, the scope of the present disclosure is limited by only the appended claims and equivalents thereof.

1. An electronic device for a transmitting end apparatus of sidelink communications, comprising:
at least one processor; and
at least one memory including computer program code, where the at least one memory and the computer program code are configured, with the at least one processor, to cause the electronic device to:
generate sidelink control information (SCI) in performing beam-based communication with a receiving end apparatus of the sidelink communications, the SCI comprising information of resource utilization and/or preservation conditions of a communication beam in previous sidelink communications of the transmitting end apparatus; and
carry the SCI on a control channel to be transmitted to the receiving end apparatus via a current beam.

2. The electronic device according to claim 1, wherein, the SCI comprises first SCI and at least one second SCI, the first SCI comprising information of resource utilization and/or preservation conditions of the current beam, and the at least one second SCI comprises information of resource utilization and/or preservation conditions of a communication beam in the previous sidelink communications, wherein the first SCI corresponds to a first control channel, the at least one second SCI corresponds to at least one second control channel, the first control channel occupies a first sub-channel in the frequency domain, the at least one second control channel occupies at least one second sub-channel in the frequency domain, and the first sub-channel and the at least one second sub-channel correspond to different frequencies, respectively.

3. (canceled)

4. The electronic device according to claim 2, wherein each control channel occupies 2 or 3 orthogonal frequency division multiplexing (OFDM) symbols in

5. The electronic device according to claim 4, wherein the first sub-channel is a sub-channel of a lowest frequency for transmission resources, and the at least one second sub-channel is sub-channels with frequencies increased sequentially from the lowest frequency for the first sub-channel.

6. The electronic device according to claim 4, wherein the first SCI comprises a first field for indicating whether there is at least one second control channel, and the second SCI comprises a first field for indicating whether there is a subsequent second control channel in a direction away from a frequency of the first control channel.

7. The electronic device according to claim 6, wherein the first field is located in a first stage SCI and occupies 1 bit, and is configured to: indicate absence of a second control channel in a case where the first field of the first SCI is assigned with a value of 0, and indicate absence of a subsequent second control channel in a case where the first field of the second SCI is assigned with a value of 0.

8. The electronic device according to claim 6, wherein the second SCI comprises, in addition to the first field, only information of resource utilization and/or preservation conditions of a communication beam in the previous sidelink communications.

9. The electronic device according to claim 2, wherein the SCI comprises the first SCI and one second SCI, the first SCI comprises a first field for indicating whether the second SCI exists, and the second SCI comprises only information of resource utilization and/or preservation conditions of a communication beam in one or more previous sidelink communications, wherein the first SCI further comprises a second field for indicating whether the second SCI comprises only information of resource utilization and/or preservation conditions of a communication beam in previous sidelink communications.

10. (canceled)

11. The electronic device according to claim 2, wherein at least one memory and the computer program code are further configured, with the at least one processor, to cause the electronic device to determine the number of second SCIs comprised in the SCI in a dynamic or static manner, wherein the number of second SCIs comprised in the SCI is configured by a base station or pre-configured.

12. (canceled)

13. The electronic device according to claim 11, wherein at least one memory and the computer program code are further configured, with the at least one processor, to cause the electronic device to determine the number of second SCIs comprised in the SCI based on a frequency domain size of time-frequency resources occupied by a current beam-based sidelink communication and the number of communication beams in the previous sidelink communications of the transmitting end apparatus.

14. The electronic device according to claim 1, wherein the SCI comprises at least information of resource utilization and/or preservation conditions of a communication beam in an immediately previous sidelink communication of the transmitting end apparatus.

15. An electronic device for a receiving end apparatus of sidelink communications, comprising:
at least one processor; and
at least one memory including computer program code, where the at least one memory and the computer program code are configured, with the at least one processor, to cause the electronic device to:
in performing beam-based communication with a transmitting end apparatus of the sidelink communications, receive a control channel in a current beam from the transmitting end apparatus; and
determine sidelink control information (SCI) based on the control channel, the SCI comprising information of resource utilization and/or preservation conditions of a communication beam in previous sidelink communications of the transmitting end apparatus.

16. The electronic device according to claim 15, wherein, the SCI comprises first SCI and at least one second SCI, the first SCI comprising information of resource utilization and/or preservation conditions of the current beam, and the at least one second SCI comprises information of resource utilization and/or preservation conditions of a communication beam in the previous sidelink communications.

17. The electronic device according to claim 16, wherein the first SCI corresponds to a first control channel, the at least one second SCI corresponds to at least one second control channel, the first control channel occupies a first sub-channel in the frequency domain, the at least one second control channel occupies at least one second sub-channel in the frequency domain, and the first sub-channel and the at least one second sub-channel correspond to different frequencies, respectively.

18. The electronic device according to claim 17, wherein each control channel occupies 2 or 3 orthogonal frequency division multiplexing (OFDM) symbols in the time domain.

19. (canceled)

20. The electronic device according to claim 17, wherein the first SCI comprises a first field for indicating whether there is at least one second control channel, and the second SCI comprises a first field for indicating whether there is a subsequent second control channel in a direction away from a frequency of the first control channel.

21-25. (canceled)

26. An electronic device for a transmitting end apparatus of sidelink communications, comprising:
at least one processor; and
at least one memory including computer program code, where the at least one memory and the computer program code are configured, with the at least one processor, to cause the electronic device to:
generate sidelink control information (SCI) and carry the SCI on a control channel in performing beam-based communication with a receiving end apparatus of the sidelink communications; and
transmit the control channel via a first beam and transmit a data channel via a second beam in one time slot, wherein, a beam width of the first beam is larger than a beam width of the second beam.

27. The electronic device according to claim 26, wherein the first beam is an omnidirectional beam.

28. The electronic device according to claim 26, wherein an interval for automatic gain control is set between the control channel and the data channel.

29. The electronic device according to claim 26, wherein, the SCI comprises first SCI and at least one second SCI, the first SCI comprising information of resource utilization and/or preservation conditions of the first beam and the second beam, and the at least one second SCI comprises information of resource utilization and/or preservation conditions of a communication beam in the previous sidelink communications of the transmitting end apparatus.

30-38. (canceled)
